(19) United States
(12) Patent Application Publication
(10) Pub. No.: US 2008/0246988 A1
(43) Pub. Date: Oct. 9, 2008

(54) Adaptive printer pools

(76) Inventor: Anthony Arnol Ashton, Vancouver, WA (US)

Correspondence Address: SHARP LABORATORIES OF AMERICA, INC., 1320 PEARL ST., SUITE 228, BOULDER, CO, 80302, US

(21) Appl. No.: 11/784,703

(22) Filed: Apr. 9, 2007

(51) Int. Cl. G06K 1/00

(52) U.S. Cl. 358/1.15

(57) ABSTRACT

A client node in a networked printing system outputs in response to a change to an individual print setting input by a user for a print job a real-time update of printing nodes selectable by the user to process the print job. By presenting a user of the client node with a pool of selectable printing nodes that automatically adapts to changes in print settings, inefficiencies of prior processes that require the user to individually assess compatibility of printing nodes with print settings and the pitfalls of prior processes that automatically select a “best fit” printing node that may be compatible with print settings but is undesirable from the user's perspective are avoided. Moreover, by providing a user with immediate feedback on the impact of a change to an individual print setting on the selectable status of printing nodes, the user is able to quickly and accurately determine a combination of print settings and printing node that is desirable from the user's perspective.

### BACKGROUND OF THE INVENTION

The present invention relates to efficient distribution of print jobs in a multi-printer network and, more particularly, to allowing a user to quickly and accurately identify a printer for processing a print job that is desirable from the user's perspective.

A communication network, such as a corporate, campus or home office network, often includes many printing nodes that service many client nodes. These printing nodes have different capabilities over time. To ensure that a print job is completed as efficiently as possible in such a network, a user of a client node must often judiciously select a printing node to which to send the print job from among multiple printing nodes. This requires that the user of the client node have ready access to accurate and current information on the capabilities of the multiple printing nodes. When the user of the client node does not have ready access to such information, the user may undesirably select a printing node that is inaccessible, incapable, inconvenient or too busy. At best this can lead to delayed completion of the print job and at worst can require the user to cancel the print job and send it to a different printing node.

Processes that inform a user of a client node of the current capabilities of printing nodes are known. Such processes generally present the user of the client node with the current capabilities of individual printing nodes at the user's request. Once the user has identified a presently capable printing node, the user sends the print job to the printing node. However, these known processes suffer from several shortcomings. For one, these processes generally require the user to individually review the capabilities of printing nodes and manually compare the capabilities of the individual printing nodes with the print settings chosen by the user for compatibility. Moreover, these processes typically do not apprise the user of the location of the individual printing nodes.

More highly automated processes for selecting a printing node to process a print job are also known. For example, U.S. Patent Publication No. 2003/0117638 describes a virtual print driver for a client node that automatically identifies one or more “best fit” printing nodes for a print job based on an assessment of capabilities and automatically dispatches the print job if a single “best fit” node is identified. However, the criteria used by the selection algorithm to identify the one or more “best fit” printing nodes may not comport with the user's preferences. For example, the selection algorithm may prioritize printer availability over proximity, whereas the user may prefer a closer printer with lower availability, resulting in an undesirable selection from the user's perspective. The problem is exacerbated when the print job is automatically sent to an undesirable printing node. Moreover, the identification of the “best fit” node or nodes is not made until after all print settings have been chosen by the user. Thus, where the selection algorithm finds no “best fit” nodes or only finds “best fit” nodes that are undesirable from the user's perspective (for example, because they are too remote from the user or insufficiently available), the user is left to guess which print settings chosen by the user created incompatibilities of the print job with more desirable printing nodes.

### SUMMARY OF THE INVENTION

The present invention, in a basic feature, outputs in response to a change to an individual print setting input by a user for a print job a real-time update of printing nodes selectable by the user to process the print job. By presenting a user with a pool of selectable printing nodes that automatically adapts to changes in print settings, the present invention avoids inefficiencies of prior processes that require the user to individually assess compatibility of printing nodes with print settings, while also avoiding the pitfalls of prior processes that automatically select a “best fit” printing node that may be compatible with print settings but is undesirable from the user's perspective. Moreover, by providing a user with immediate feedback on the impact of a change to an individual print setting on the selectable status of printing nodes, the user is able to quickly and accurately determine a combination of print settings and printing node that is desirable from the user's perspective.

In one aspect, a method for facilitating selection of a printing node from among a plurality of printing nodes to process a print job initiated on a client node comprises inputting on the client node a change to an individual print setting for the print job and outputting on the client node in response to the print setting change a real-time indication of a changed selectable status for processing the print job for at least one printing node within the plurality.

In another aspect, a client node comprises a user interface and a processor communicatively coupled with the user interface wherein the processor is adapted to receive from the user interface a change to an individual one of a plurality of print settings, immediately invoke a status database in response to the change and determine an impact of the change on a selectable status for processing a print job for each of a plurality of printing nodes and immediately present on the user interface in response to the determination an indication of the selectable status.

In another aspect, a print driver for a client node connected by a communication network with a plurality of printing nodes comprises a first process adapted to receive from the printing nodes through the communication network status data indicative of capabilities of the printing nodes and a second process adapted to update immediately in response to a change to an individual one of a plurality of print settings for a print job and based at least in part on the status data a selectable status for processing the print job for each of the printing nodes.

These and other aspects of the invention will be better understood by reference to the detailed description of a preferred embodiment taken in conjunction with the drawings briefly described below. Of course, the scope of the invention is defined by the appended claims.

### BRIEF DESCRIPTION OF THE DRAWINGS

FIG. 1 shows a networked printing system in one embodiment of the invention.

FIG. 2 shows a client node in one embodiment of the invention.

FIG. 3 shows contents of a memory on a client node in one embodiment of the invention.

FIG. 4A shows a first exemplary user screen displayed to a user of a client node in one embodiment of the invention.

FIG. 4B shows a second exemplary user screen displayed to a user of a client node in one embodiment of the invention.

FIG. 4C shows a third exemplary user screen displayed to a user of a client node in one embodiment of the invention.

FIG. 4D shows a fourth exemplary user screen displayed to a user of a client node in one embodiment of the invention.

FIG. 5 is a flow diagram showing a method for facilitating selection of a printing node from a plurality of printing nodes to receive a print job from a client node in one embodiment of the invention.

FIG. 6 is a flow diagram showing a method for facilitating selection of a printing node from a plurality of printing nodes to receive a print job from a client node in another embodiment of the invention.

### DETAILED DESCRIPTION OF A PREFERRED EMBODIMENT

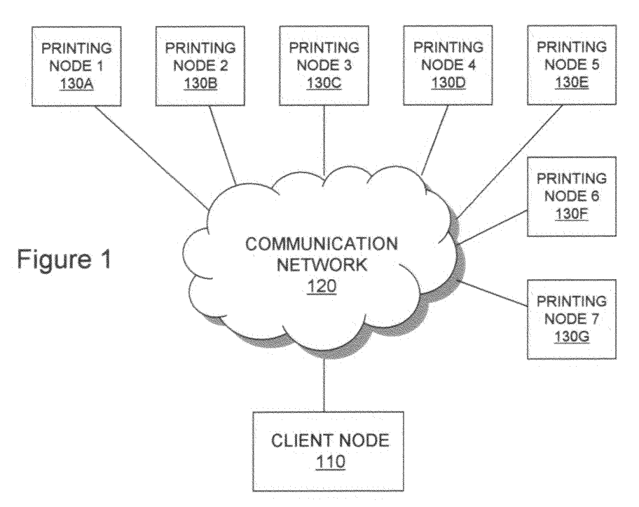

In FIG. 1, a networked printing system is shown in one embodiment of the invention. The networked printing system includes a client node 110 and multiple printing nodes 130 communicatively coupled via a communication network 120. While seven printing nodes are shown for illustrative purposes, the number may vary. The client node 110 is a network capable processing device having a user interface, such as a personal computer, workstation, personal data assistant or other hand-held processing device, for example. The printing nodes 130 are network capable printing devices such as single function printers that support only printing facilities or multifunction printers that support printing facilities as well as other reproduction facilities such as copying, scanning and faxing, for example. Communication network 120 is a digital communication network such as a wired or wireless LAN or WAN. Client node 110 and printing nodes 130 communicate using one or more LAN or WAN protocols such as wired Ethernet (IEEE Std. 802.3), Wi-Fi (IEEE Std. 802.11), Token Ring, FDDI, ATM, Frame Relay, MPLS, TCP/IP, IPX or AppleTalk, for example. Client node 110 receives status data on capabilities of print nodes 130 and sends print jobs initiated on client node 110 to print nodes 130 that are selected based at least in part on the status data in a manner hereinafter described. A print job may involve, for example, printing an electronic document or image on a substrate such as paper.

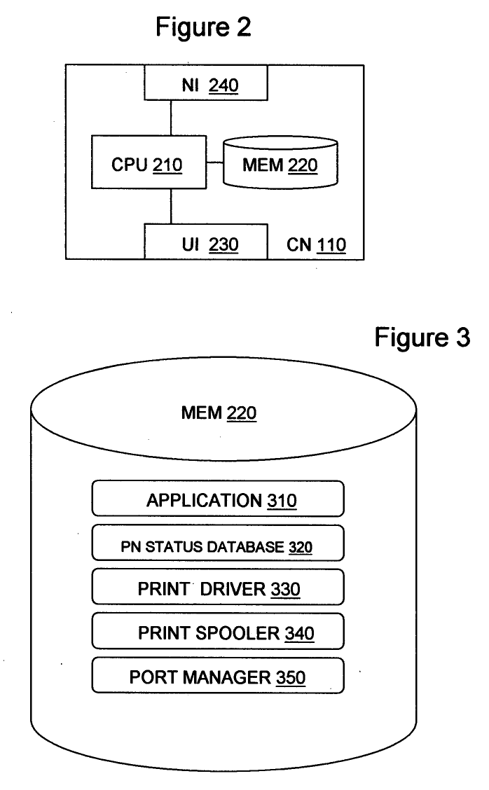

In FIG. 2, client node 110 is shown in more detail. Client node 110 includes a processor (CPU) 210 communicatively coupled with a memory 220, a user interface 230 and a network interface 240. Processor 210 may include one or more general purpose processors, application processors or microcontrollers, for example. Memory 220 may include one or more data storage elements implemented in RAM, ROM or EPROM, for example. User interface 230 includes one or more input elements, such as a keyboard or keypad, and one or more output elements, such as a monitor or display. Network interface 240 includes a communications interface, such as a wired Ethernet interface or a Wi-Fi interface.

In FIG. 3, memory 220 is shown in more detail. Memory 220 has stored thereon numerous processes executable by processor 210. Processes may be software programs having instructions executable by processor 210, for example. Processes include application 310, print driver 330, print spooler 340 and port manager 350. Application 310 includes one or more processes initiated by a user of client node 110, such as a Microsoft Office® application, within which the user may request a print job. Print driver 330 includes one or more processes for interfacing with application 310 to receive print jobs requests made within application 310, for monitoring status of printing nodes 130, for normalizing status data received from printing nodes 130 to enable direct comparison of current capabilities of printing nodes 130 with current status of print settings, for maintaining current capabilities of printing nodes 130 in status database 320, for maintaining current status of print settings, for comparing current capabilities of printing nodes 130 and current status of print settings to determine selectable printing nodes, for presenting user screens on user interface 230 with current print settings and identification of selectable printing nodes, for processing inputs received on user screens including changes to print settings and selections of printing nodes 130 to process print jobs, for receiving print jobs from application 310 and for de-spooling print jobs to print spooler 340. Print spooler 340 includes one or more processes for receiving print jobs de-spooled from print driver 330 and for de-spooling print jobs to selected printing nodes via network interface 240 under the direction and control of port manager 350. Port manager 350 includes one or more processes for formatting and scheduling print jobs for transmission on communication network 120.

Printing node status database 320 is a relational database for storing status data on printing nodes 130. Stored status data includes a node ID and node capability information. Node capability information may include, for example, print job finishing options, printer supply information, printer configuration information, printer security settings, printer location information and printer availability information. Finishing options may include, for example, color options (e.g. black and white only, color), layout options (e.g. portrait, landscape), print order (e.g. front to back, back to front), print quality (e.g. best, normal, draft), paper size (e.g. A4, envelope, index card, legal, letter), style (e.g. one-sided, two-sided), binding edge (e.g. left, top) and binding type (e.g. two-hole punch, three-hole punch, staple). Supply information may include, for example, toner availability and paper availability. Security settings may include, for example, access control lists (ACL) and time restrictions. Location information may include, for example, a building, team, workgroup or VLAN ID, IP subnet membership and GPS position. Availability information may include, for example, current and average queue length and CPU usage.

Status data in status database 320 is updated by print driver 330. In some embodiments, print driver 330 continually monitors printing nodes 130 by periodically sending status request messages via communication network 120 to printing nodes 130 and receiving status reply messages including status data via communication network 120 from printing nodes 130. In other embodiments, print driver 330 receives unsolicited status messages including status data from printing nodes 130. In still other embodiments, print driver 330 sends status request messages to printing nodes 130 when a print job is requested on client node 110. Status request messages may be broadcast, multicast or unicast messages. Status data may be obtained using a network management protocol, such as SNMP, in which case print driver 330 may serve as an SNMP manager and printing nodes 130 may serve as SNMP agents and in which status data may be obtained by the SNMP manager through periodic polling, SNMP traps, or both. Status data may be stored in the form provided by printing nodes 130 or may be normalized by print driver 330 prior to storage to enable direct comparison with print settings for compatibility.

In some embodiments, status database 320 may reside outside of client node 110 in communication network 120. However, it will be appreciated that the remote database access via communication network 120 required in such embodiments may render the networked printing system less robust.

Status data in status database 320 is applied to facilitate selections among printing nodes 130 to process print jobs. In operation, a user of client node 110 starts application 310 through inputs on user interface 230. Within application 310, the user requests a print job through further inputs on user interface 230, such as by issuing a “Print” command. Once a print job is requested, print driver 330 is invoked. Print driver 330 searches status database 320 and determines which ones of printing nodes 130 have capabilities that are compatible with default print settings and are otherwise accessible to client node 110. A printing node having capabilities compatible with default print settings may be otherwise inaccessible due to, for example, being off-line. Print driver 330 then presents a user screen on user interface 230 showing the default print settings and the selectable status of printing nodes, which allows a user to distinguish between printing nodes that are selectable for processing the print job under the default print settings from printing nodes that are non-selectable to process the print job under the default print settings. Print settings may include, for example, print job finishing preferences, a printer location preference and a printer availability preference.

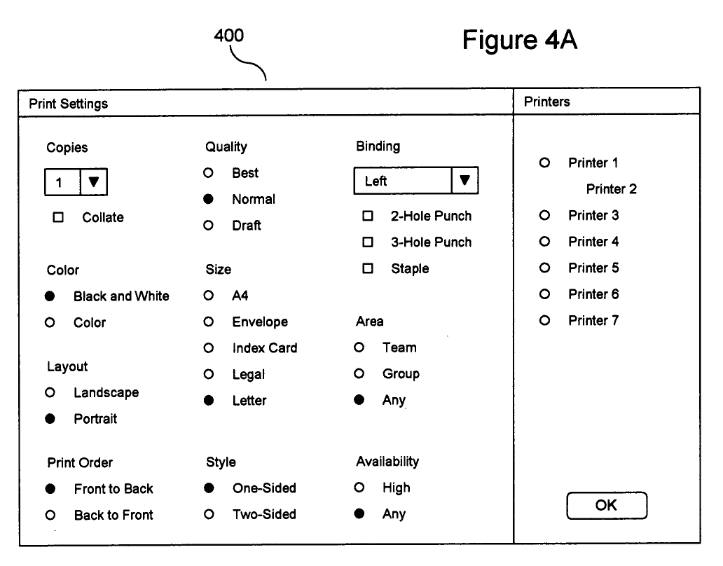

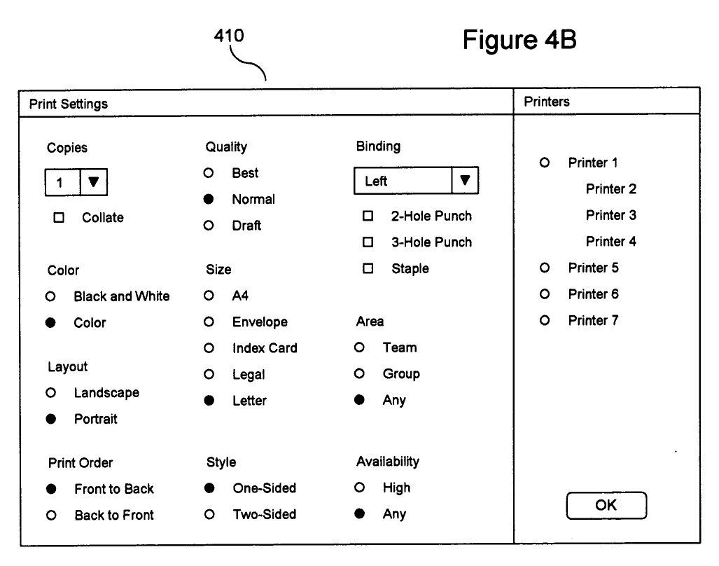

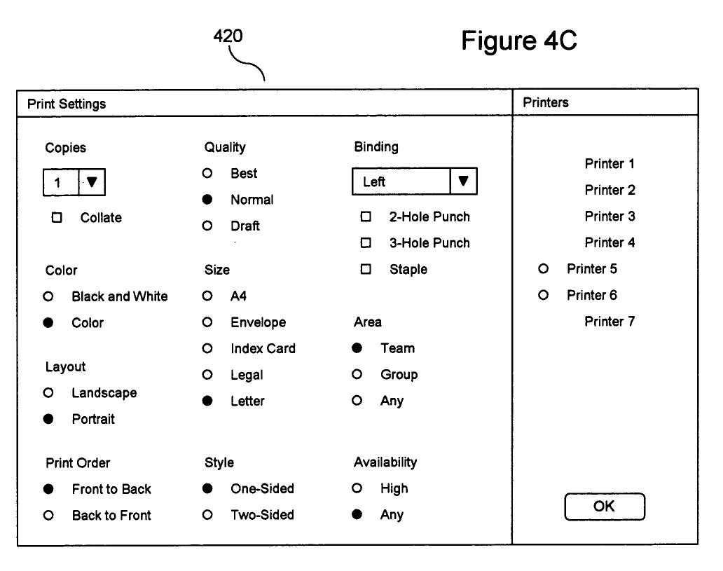

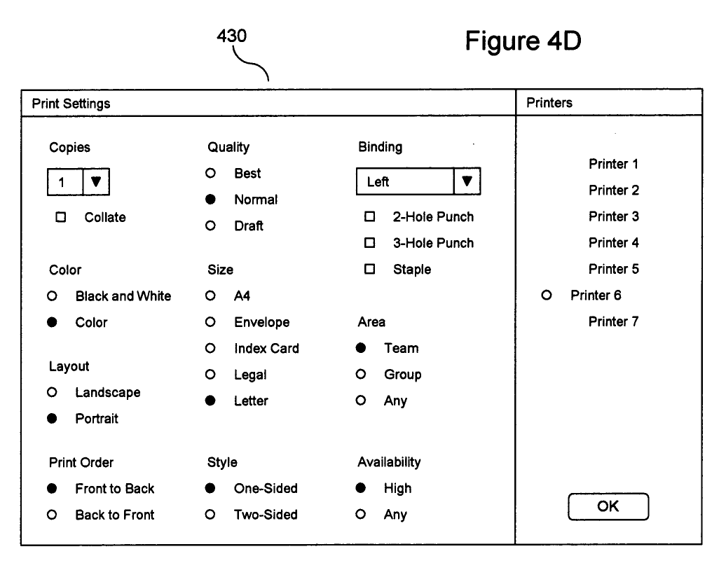

Turning to FIG. 4A, an exemplary default user screen 400 is shown. Screen 400 includes a left hand side displaying print settings and a right hand side displaying a list of printing nodes 130. Default print settings are represented on screen 400 by selected radio buttons, selected check boxes and visible entries in pull-down menus. Ones of printing nodes 130 that are compatible with the default print settings and are otherwise accessible to client node 110 (in this example printers 1 and 3-7 representing print nodes 130A and 130C through 130G, respectively) are indicated to be selectable for processing the print job through the presence of an associated selectable radio button. Ones of printing nodes 130 that are not accessible due to an incompatibility with the default print settings or for other reasons (in this example printer 2 representing print node 130B) are indicated to not be selectable for processing the print job through the absence of an associated selectable radio button and indentation. Naturally, selectable printing nodes and non-selectable printing nodes may be distinguished on a user screen by numerous alternative means, such as highlighting, boldfacing, capitalization, italicization, strikethrough or underlining, for example.

Presented with default user screen 400, the user may proceed to change print settings, such as finishing options, printer proximity or printer availability, for example, to comport with user preferences for the requested print job. Advantageously, in response each such change, the user is presented with a real-time on screen update indicating which ones of printing nodes 130 are impacted by the change. Turning to FIG. 4B, for example, an exemplary user screen 410 is shown which reflects a user's singular change from the default user screen 400 of the “Color/” print setting from “Black and White” to “Color”. In response to the change, the user is presented in real-time with screen 410 indicating that printers 3 and 4 (representing print nodes 130C and 130D) have become non-selectable as a result of the change. More particularly, immediately in response to the change made by user input, print driver 330 searched status database 320 and determined that printers 3 and 4 are black and white only printers and no longer have capabilities compatible with the current print settings, and immediately rendered screen 410 in response to the determination.

Continuing on, in FIG. 4C, an exemplary user screen 420 is shown which reflects the user's singular change from user screen 410 of the “Area” print setting from “Any” to “Team”. Such a change may have been made out of the user's preference for a printer that is closer to the user, for example. In response to the change, the user is presented in real-time with user screen 420 indicating that printers 1 and 7 (representing printing nodes 130A and 130G) have become non-selectable as a result of the change. More particularly, immediately in response to the change made by user input, print driver 330 searched status database 320 and determined that printers 1 and 7 are not assigned to the same team as client node 110 (or as the user) at present and no longer have capabilities compatible with the current print settings, and immediately rendered screen 420 in response to the determination.

Finally, in FIG. 4D, an exemplary user screen 430 is shown which reflects the user's singular change from user screen 420 of the “Availability” print setting from “Any” to “High”. This change may have been made out of the user's preference for a printer that has low utilization at present and can therefore quickly process the print job. In response to the change, the user is presented in real-time with user screen 430 indicating that printer 5 (representing printing node 130E) has become non-selectable as a result of the change. More particularly, immediately in response to the change made by user input, print driver 330 searched status database 320 and determined that printer 5 has a low availability profile at present and no longer has capabilities compatible with the current print settings, and immediately rendered screen 430 in response to the determination.

In some embodiments, a change to a print setting is deemed effective by print driver 330 upon a user's modification of the setting. In other embodiments, a change to a print setting is deemed effective by print driver 330 upon a user's modification of the setting followed by selection of an application button such as an “Apply” or “OK” button.

Naturally, the above user screens are merely exemplary. User screens in other embodiments may have different print settings, different printers and different on screen selection mechanisms, for example. Nonetheless, a significant advance manifested by user screens in various embodiments of the invention is believed to reside in providing a user with immediate feedback on the impact of an individual print setting change on the selectable status of printing nodes, such that the user is able to determine quickly and accurately a combination of print settings and a printing node that is desirable from the user's perspective.

Once the user has identified a combination of print settings and a printing node that is desirable from the user's perspective, the user selects the printing node. For example, after the user's changes to print settings that led to user screen 430 of FIG. 4D, the user is presented with print settings and a lone selectable printing node (printer 6 representing printing node 130F). The user selects printing node 130F and clicks “OK”. Such user action prompts print driver 330 to de-spool the print job to print spooler 340, which in turn de-spools the print job to printing node 130F via network interface 240 and communication network 120 under the direction and control of port manager 350. Upon receipt of the print job by printing node 130F, printing node 130F processes the print job to produce printed output, possibly after a queuing delay.

In other embodiments, instead of direct transmission of the print job to the selected printing node, the print job may be transmitted to an intermediate print monitor, processor, spooler or server node (not shown) in communication network 120 for redirection to printing node 130F.

In still other embodiments, the user may select multiple printing nodes for processing a print job resulting in splitting of the print job among multiple printing nodes. In that event, client node 110 may de-spool the print job directly to multiple printing nodes via a multicast transmission, or may de-spool the print job to an intermediate print monitor, processor, spooler or server node in communication network 120 via a unicast transmission for splitting by the print monitor, processor, spooler or server node.

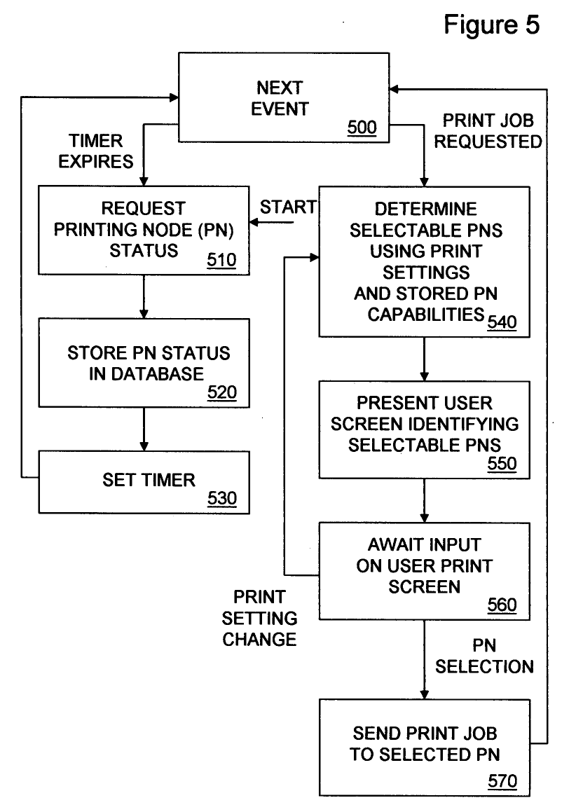

Turning now to FIG. 5, a method for facilitating selection of a printing node from among printing nodes 130 to receive a print job from client node 110 is shown in one embodiment of the invention. In the illustrated embodiment, client node 110 continually monitors printing nodes 130 for status, including capabilities. At the start of operation, print driver 330 requests status of printing nodes 130 (510) through transmission of status requests to printing nodes 130. In response to status requests, print driver 330 receives status replies from printing nodes 130 and stores the status of printing nodes 130, including capabilities, in status database 320 (520). Print driver 330 then sets a timer (530) and awaits an event (500). If the event is expiration of the timer, print driver 330 again requests the status of printing nodes 130 (510) through transmission of status requests, receives status replies from printing nodes 130, updates the status of printing nodes in status database 320 (520) and resets the timer (530). If the event is a print job request, print driver 330 determines using default print settings and printing node status data accessed in status database 320 which ones of the printing nodes 130 are selectable for processing the print job (540). Upon making that determination, print driver 330 renders on user interface 230 a user screen identifying selectable printing nodes (550) and awaits a user input (560). If the user input is a selection of a printing node from among the identified selectable printing nodes, the print job is dispatched to the selected printing node (570) and print driver 330 awaits the next event (500). If, however, the user input is a change to an individual print setting, print driver 330 immediately updates using the current print settings and printing node capabilities accessed in status database 320 which ones of the printing nodes 130 are now selectable for processing the print job in view of the change (540), renders on user interface 230 an updated user screen identifying selectable printing nodes (550) and awaits a further user input (560).

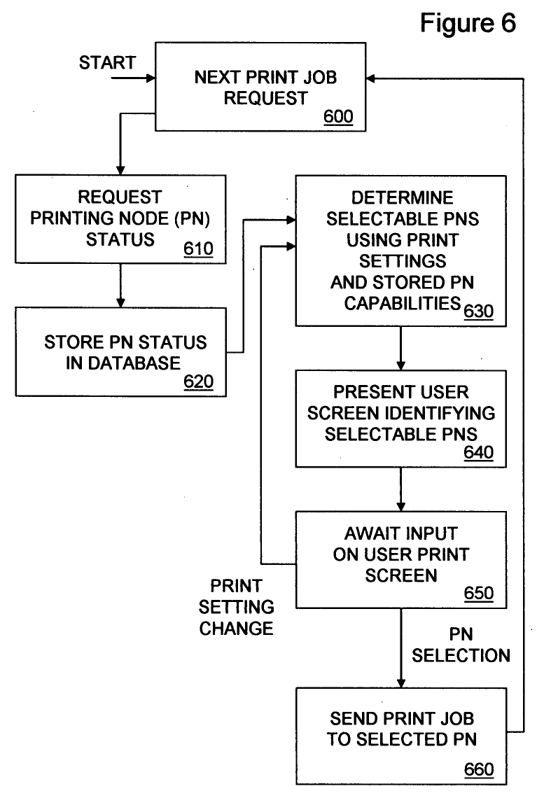

Turning to FIG. 6, a method for facilitating selection of a printing node from among printing nodes 130 to receive a print job from client node 110 is shown in another embodiment of the invention. In this embodiment, client node 110 updates status, including capabilities, of printing nodes 130 upon receipt of a print job request instead of periodically. At the start of operation, awaits a print job request (600). Upon receipt of a print job request, print driver 330 requests the status of printing nodes 130 (610) through transmission of status requests to printing nodes 130. In response to status requests, print driver 330 receives status replies from printing nodes 130 and stores the status of printing nodes 130 in status database 320 (620). Print driver 330 then determines using default print settings and printing node status data accessed in status database 320 which ones of the printing nodes 130 are selectable for processing the print job (630). Upon making that determination, print driver 330 renders on user interface 230 a user screen identifying selectable printing nodes (640) and awaits a user input (650). If the user input is a selection of a printing node from among the identified selectable printing nodes, the print job is dispatched to the selected printing node (660) and print driver 330 awaits the next print job request (600). If, however, the user input is a change to an individual print setting, print driver 330 immediately updates using the current print settings and printing node capabilities accessed in status database 320 which ones of the printing nodes 130 are now selectable for processing the print job in view of the change (630), renders on user interface 230 an updated user screen identifying selectable printing nodes (640) and awaits a further user input (650).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for facilitating selection of a printing node from among a plurality of printing nodes to process a print job initiated on a client node, comprising:
inputting on the client node a change to an individual print setting for the print job; and
outputting on the client node in response to the print setting change a real-time indication of a changed selectable status for processing the print job for at least one printing node within the plurality.

2. The method of claim 1, wherein the changed selectable status is indicative of a change from selectable to non-selectable.

3. The method of claim 1, wherein the changed selectable status is indicative of a change from non-selectable to selectable.

4. The method of claim 1, further comprising:
receiving on the client node status data indicative of capabilities of the plurality of printing nodes prior to the inputting step; and
using the status data to determine the changed selectable status prior to the outputting step.

5. The method of claim 1, wherein the print setting comprises a print job finishing preference.

6. The method of claim 1, wherein the print setting comprises a printer location preference.

7. The method of claim 1, wherein the print setting comprises a printer availability preference.

8. The method of claim 1, wherein the print setting change is deemed effective upon modification of the print setting on a user screen.

9. The method of claim 1, wherein the print setting change is deemed effective upon modification of the print setting followed by selection of an application button on a user screen.

10. A client node, comprising:
a user interface; and
a processor communicatively coupled with the user interface,
wherein the processor is adapted to receive from the user interface a change to an individual one of a plurality of print settings, immediately invoke a status database in response to the change and determine an impact of the change on a selectable status for processing a print job for each of a plurality of printing nodes and immediately present on the user interface in response to the determination an indication of the selectable status.

11. The node of claim 10, wherein the status database resides on the node.

12. The node of claim 10, further comprising a network interface wherein the processor is adapted to receive via the network interface from each of the plurality of printing nodes status data indicative of capabilities of each of the plurality of printing nodes and apply the status data in the determination.

13. The node of claim 12, wherein the processor is further adapted to request via the network interface the status data from each of the plurality of printing nodes.

14. The node of claim 12, wherein the processor is further adapted to periodically request via the network interface the status data from the printing nodes.

15. The node of claim 12, wherein the processor is further adapted to request via the network interface the status data from the printing nodes upon receipt of a print job request.

16. The node of claim 12, wherein the status data comprises at least one of print job finishing information, printer location information and printer availability information.

17. A print driver for a client node connected by a communication network with a plurality of printing nodes, comprising:
a first process adapted to receive from the printing nodes through the communication network status data indicative of capabilities of the printing nodes; and
a second process adapted to update immediately in response to a change to an individual one of a plurality of print settings for a print job and based at least in part on the status data a selectable status for processing the print job for each of the printing nodes.

18. The print driver of claim 17, further comprising a third process adapted to present immediately in response to the update a user screen indicating the selectable status.

19. The print driver of claim 17, wherein the first process is adapted to request the status data from the printing nodes periodically.

20. The print driver of claim 17, wherein the first process is adapted to request the status data from the printing nodes upon receipt of a print job request.
